(19) United States
(12) Patent Application Publication
(10) Pub. No.: US 2010/0302323 A1
(43) Pub. Date: Dec. 2, 2010

(54) FLUID DISCHARGE HEAD AND IMAGE FORMING APPARATUS

(76) Inventors: Masahiro YAGI, Kanagawa (JP); Kenji Asuwa, Kanagawa (JP); Dongsik Jang, Kanagawa (JP); Yoshikazu Akiyama, Kanagawa (JP); Eiichi Ohta, Kanagawa (JP); Yukitoshi Tajima, Kanagawa (JP); Takeshi Takemoto, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/765,350

(22) Filed: Apr. 22, 2010

(30) Foreign Application Priority Data
Jun. 1, 2009 (JP) 2009-131927

(51) Int. Cl. B41J 2/045

(52) U.S. Cl. 347/70

(57) ABSTRACT

A fluid discharge head includes a fluid chamber filled with ink; a discharge opening configured to discharge a droplet of ink from the fluid chamber; a plurality of piezoelectric elements configured as displacement generating units to provide kinetic energy to the ink for the discharge of the ink droplet; and a vibrating plate forming a part of the fluid chamber and connected to the piezoelectric elements, the vibrating plate being configured to transmit a displacement generated by the piezoelectric elements to the ink in the fluid chamber. The vibrating plate includes vibrating portions for the respective the piezoelectric elements. The vibrating portions are configured to be independently displaced for the corresponding piezoelectric elements, and at least one of the piezoelectric elements is configured as a pressure detecting unit to detect an ink pressure in the fluid chamber.

### BACKGROUND OF THE INVENTION

1. Field of the Invention

The present invention generally relates to fluid discharge heads and image forming apparatuses. More particularly, the invention relates to a fluid discharge head suitable for printing a high-quality image and an image forming apparatus having the fluid discharge head.

2. Description of the Related Art

There are various image forming apparatuses, such as printers, facsimile machines, copiers, and multifunction peripherals combining printer, facsimile, and copy functions. As one example of such image forming apparatus, an inkjet printer is known. Typically, an inkjet printer has a recording head (fluid discharge head) configured to discharge droplets of a recording fluid, such as ink, onto a recording medium (which may be referred to as a “sheet”, a “recorded medium”, a “transfer material”, or a “recording paper”, whose material is not particularly limited) as the sheet is transported. As a result, the recording fluid attaches to the sheet, forming (i.e., recording, printing, transferring, or transcribing) a desired image on the sheet.

Two types of fluid discharge heads are widely employed. The first type applies a voltage to a piezoelectric element in order to apply pressure into a fluid chamber filled with ink, thereby providing kinetic energy to the ink in the fluid chamber and causing the ink to be discharged out of a nozzle and land on the recording medium. The second type employs a heat-generating resistor to produce vapor bubbles in the fluid chamber.

The vapor bubbles provide kinetic energy to the ink in the fluid chamber so that the ink can be discharged out of the nozzle and land on the recording medium.

In both types, the fluid discharge head is designed (such as the shape of nozzle, the shape of fluid chamber, and the material of the head) depending on the physical properties of the ink used and the physical properties of the recording medium on which the ink lands. The physical properties of the ink may include viscosity, surface tension, contact angle, medium permeability, molecular weight, heat conductivity, and density. The physical properties of the recording medium may include basis weight, thickness, smoothness, and presence/absence of a coating layer. These properties are optimized so that speed, cost, and quality of the inkjet system can be balanced.

The fluid discharge head needs to be capable of discharging ink stably in spite of various disturbances, such as changes in the physical property of the ink in the fluid chamber due to changes in ambient temperature or humidity; attachment of dust on the nozzle; entry of dust into the fluid chamber; drying of ink in the nozzle; and entry of air into the fluid chamber.

In order to ensure stable discharge of ink, a system discussed in Japanese Laid-Open Patent Application No. 2006-88475 provides a pressure sensor in the fluid chamber. The pressure sensor detects a pressure in the fluid chamber and also monitors pressure characteristics upon discharge. If an abnormality is detected by the pressure sensor, ink is sucked via a nozzle. However, according to this technology, plural piezoelectric elements need to be disposed in a complex way, and also a number of layers need to be formed, resulting in a high-cost inkjet head structure requiring a number of complex manufacturing steps. Further, because the pressure sensor is dedicated for pressure detecting purpose, it keeps measuring pressure even when it is not required to (such as in the period between the end of discharge and the time immediately before the start of next discharge in a continuous series of discharge operation). Thus, the inkjet head unit of this known system has low cost performance.

### SUMMARY OF THE INVENTION

The disadvantages of the prior art may be overcome by the present invention which, in one aspect, is a fluid discharge head including a fluid chamber configured to be filled with ink; a discharge opening configured to discharge a droplet of ink from the fluid chamber; a plurality of piezoelectric elements configured as displacement generating units to provide kinetic energy to the ink for the discharge of the ink droplet; and a vibrating plate forming a part of the fluid chamber and connected to the piezoelectric elements, the vibrating plate being configured to transmit a displacement generated by the piezoelectric elements to the ink in the fluid chamber. The vibrating plate includes vibrating portions for the respective piezoelectric elements. The vibrating portions are configured to be independently displaced for the corresponding piezoelectric elements. At least one of the piezoelectric elements is configured as a pressure detecting unit to detect an ink pressure in the fluid chamber.

In another aspect, the invention is an image forming apparatus including the above fluid discharge head.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a cross section of an inkjet head according to an embodiment of the present invention;

FIG. 2 is a bottom view of a cross section taken along the broken line A-A′ of FIG. 1;

FIG. 3 is a graph indicating an example of piezoelectric characteristics;

FIG. 4 is a cross section of an inkjet head according to an embodiment of the present invention;

FIG. 5 is a bottom view of a cross section taken along the broken line A-A′ of FIG. 4;

FIG. 6 is a graph indicating stress-strain curves of different vibrating plate materials;

FIG. 7 is a cross section of an inkjet head according to an embodiment of the present invention;

FIG. 8 is a cross section of an inkjet head according to an embodiment of the present invention;

FIG. 9 is a cross section of an inkjet head according to an embodiment of the present invention;

FIG. 10 illustrates a process of fabricating a piezoelectric element according to an inkjet patterning process;

FIG. 11 illustrates a process of fabricating a piezoelectric element by an optical energy process;

FIG. 12 is a perspective view of an inkjet recording apparatus according to an embodiment of the present invention; and

FIG. 13 is a side view of the inkjet recording apparatus of FIG. 12.

### DETAILED DESCRIPTION OF THE PREFERRED EMBODIMENTS

Referring now to the drawings, wherein like reference numerals designate identical or corresponding parts throughout the several views, various embodiments of the present invention are described.

### Fluid Discharge Head

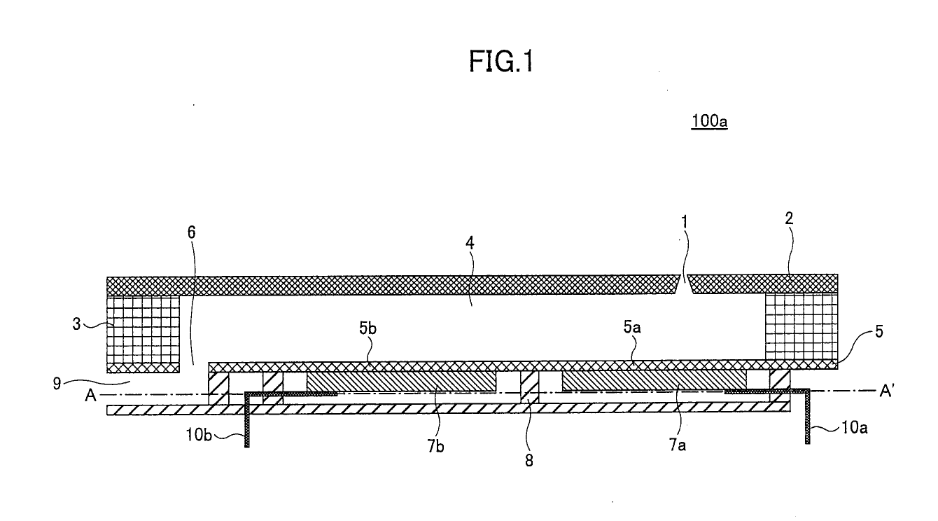

FIG. 1 is a cross section of an inkjet head (fluid discharge head) 100a according to an embodiment of the present invention. The inkjet head 100a includes a fluid chamber 4 filled with ink; a nozzle layer 2; a discharge opening 1 (nozzle) formed in the nozzle layer 2 via which an ink droplet is discharged out of the fluid chamber 4; a fluid chamber layer 3; a first and a second piezoelectric element 7a and 7b; a vibrating plate 5 forming a part of the fluid chamber 4 and attached to the first and the second piezoelectric elements 7a and 7b; a restrictor 6 which is a flow channel having a fluid resistance; a vibrating plate supporting member 8; a common channel 9; and electric wiring portions 10a and 10b. Preferably, three or more piezoelectric elements may be provided.

The first and the second piezoelectric elements 7a and 7b may be configured as a displacement generating unit or a pressure detecting unit. As a displacement generating unit, the first and the second piezoelectric elements 7a and 7b may provide kinetic energy to the ink in the fluid chamber 4 in order to discharge the ink droplet. As a pressure detecting unit, the first and the second piezoelectric elements 7a and 7b may detect a pressure in the fluid chamber 4. The vibrating plate 5 may be configured to transmit an amount of displacement produced by the first and the second piezoelectric elements 7a and 7b to the ink in the fluid chamber 4

Thus, the inkjet head 100a includes at least two piezoelectric elements, such as the first and the second piezoelectric elements 7a and 7b of the illustrated embodiment. The vibrating plate 5 is partitioned into vibrating portions 5a and 5b configured to be independently displaced for the first and the second piezoelectric elements 7a and 7b, respectively, connected to the vibrating plate 5. At least one of the two or more piezoelectric elements is used as a pressure detecting unit configured to detect an ink pressure in the fluid chamber 4 in addition to being used as the displacement generating unit.

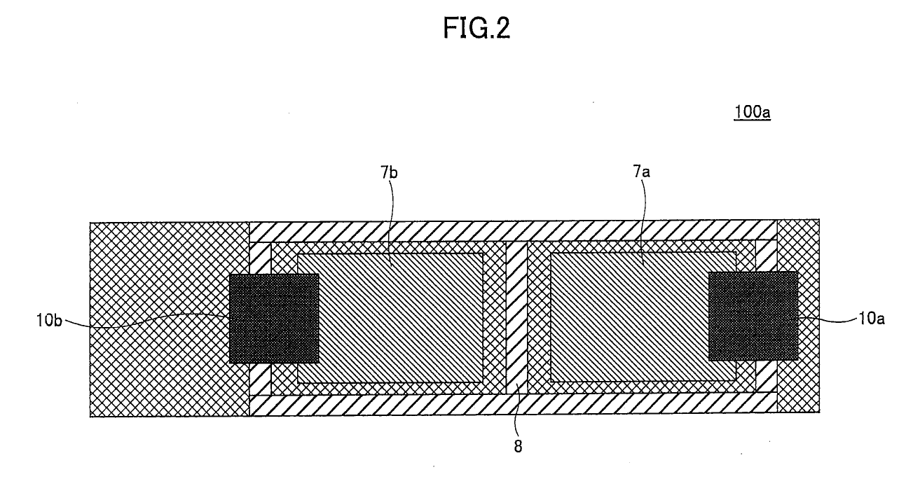

FIG. 2 is a bottom plan view of a cross section taken along broken line A-A′ of FIG. 1. As illustrated in FIG. 2, the vibrating plate supporting member 8 is disposed in such a manner as to surround the piezoelectric elements 7a and 7b individually. Thus, the vibrating plate supporting member 8 defines the separate areas on the vibrating plate 5 for the vibrating portions 5a and 5b. The vibrating plate supporting member 8 is disposed such that it does not interfere with the layout of electric wiring portions 10a and 10b which may extend outwardly from the first and the second piezoelectric elements 7a and 7b, respectively.

Thus, the first and the second piezoelectric elements 7a and 7b are disposed on the common vibrating plate 5, and the vibrating plate 5 is partitioned by the vibrating plate supporting member 8 into the independent vibrating portions 5a and 5b for the first and the second piezoelectric elements 7a and 7b. The ink may be supplied via the common channel 9 into the fluid chamber 4 via the restrictor 6.

For example, the first piezoelectric element 7a is configured to vibrate, i.e., contract and expand, in response to the supply of electric power via the electric wiring portion 10a. The vibration of the first piezoelectric element 7a is transmitted via the vibrating portion 5a to the ink in the fluid chamber 4, thereby providing a kinetic energy to the ink and causing the ink to be discharged as an ink droplet via the discharge opening 1. The ink droplet may fly through a space of several to several hundred micrometers at the speed of several meters per second before landing on a recording medium. Thus, the piezoelectric element 7a may function as an actuator. On the other hand, the pressure change in the fluid chamber 4 displaces the second piezoelectric element 7b via the second vibrating portion 5b. As a result, the second piezoelectric element 7b outputs a current indicating the amount of its displacement via the electric wiring 10b, thus detecting the pressure in the fluid chamber 4. Thus, the piezoelectric element 7b may function as a pressure sensor.

The inkjet head 100a is required to be capable of discharging the ink stably in spite of various disturbances, such as changes in ink physical property in the fluid chamber 4 due to changes in ambient temperature or humidity, which may cause changes in discharge characteristics; attachment of dust to the nozzle portion; entry of dust into the fluid chamber 4; drying of ink in the nozzle portion; and entry of air into the fluid chamber 4. Thus, by providing a pressure sensor in the fluid chamber 4 in order to detect the pressure in the fluid chamber and monitor pressure characteristics upon discharge, a restoring operation may be immediately performed upon detection of an abnormality or a sign of impending abnormality (such as the pressure waveform gradually becoming smaller in amplitude, for example). For example, in case of an abnormality, the ink may be sucked via the nozzle portion, or the inkjet head 100a may be moved to a non-printing region where a continuous discharge of ink may be performed until a stable discharge of ink can be obtained. In this way, the probability of defective image printing can be reduced.

Generally, the amount of discharged ink is determined by the nozzle diameter and the voltage and waveform of a drive signal supplied to a piezoelectric element. Therefore, a nozzle having a nozzle diameter on the order of several to several tens of μm may be made to evaluate behavior characteristics of the fluid level (meniscus) of the nozzle portion, and then the drive waveform or frequency may be optimally designed in accordance with the analyzed meniscus behavior. However, the drive waveform may be limited by the sensitivity or time response characteristics of the piezoelectric element. For example, when the piezoelectric element has a time response of μs order, the piezoelectric element cannot be controlled on a shorter time order.

The above problem can be solved by providing a plurality of piezoelectric elements. For example, after the first piezoelectric element is driven, the second piezoelectric element is driven within 1 μs of the end of driving of the first piezoelectric element, thus enabling a nanosecond-order control. Further, by driving the second piezoelectric element while the first piezoelectric element is still being driven, a more complicated control may be exerted, so that the drive waveform or frequency, for example, can be optimally designed in accordance with the meniscus behavior.

Particularly, a multi-drop control operation, in which plural droplets are combined during their flight in order to control the amount of ink that lands on the medium, generally requires a complicated drive waveform. However, in the inkjet head 100a of the present embodiment, the drive waveform or frequency can be easily optimally designed. Further, when a greater discharge energy is required than usual due to a change in the physical property of ink caused by a change in environment and the like (such as when the ambient temperature decreases and, as a result, the ink viscosity increases), a greater kinetic energy can be provided to the ink by causing the piezoelectric element that has been functioning as a detecting element to function as an actuator.

Thus, the first and the second piezoelectric elements 7a and 7b in the inkjet head 100a according to the present embodiment are configured to function as an actuator and a sensor. The actuator (displacement generating unit) is configured to provide kinetic energy to the ink so that the ink can be discharged. The sensor (pressure detecting unit) is configured to detect a pressure in the fluid chamber 4.

In order for the plural piezoelectric elements to perform the independent functions of an actuator and a sensor simultaneously, the piezoelectric elements need to be capable of operating independently. If there are no independent vibrating portions for the first and the second piezoelectric elements 7a and 7b, i.e., if the vibrating plate is common, an accurate detection of the pressure in the fluid chamber 4 by the second piezoelectric element 7b as the sensor may be prevented. For example, when the second piezoelectric element 7b detects a pressure in the fluid chamber 4 while the first piezoelectric element as the actuator is applying a pressure into the pressure chamber, the vibration of the first piezoelectric element 7a as the actuator may be directly transmitted to the second piezoelectric element 7b via the common vibrating plate, thus causing the second piezoelectric element 7b to vibrate.

Thus, in the inkjet head 100a of the present embodiment, the vibrating plate 5 is partitioned by the supporting member 8 into the vibrating portions 5a and 5b that are independently displaced by the corresponding piezoelectric elements 7a and 7b, so that the piezoelectric elements 7a and 7b can independently operate and perform the actuator function and the sensor function. Further, when all of the plural piezoelectric elements 7a and 7b function as actuators simultaneously, the pressure provided by each piezoelectric element can be independently controlled.

Because the plural piezoelectric elements 7a and 7b share the common vibrating plate 5, the structure of the inkjet head 100a can be simplified and the number of manufacturing steps can be reduced, thus enabling cost reduction. For example, in the embodiment illustrated in FIG. 1, the first and the second piezoelectric elements 7a and 7b may be formed on the vibrating plate 5 at relatively low cost by a spin-coat film-forming method and etching.

Preferably, at least one of the piezoelectric elements may have piezoelectric characteristics different from those of one or more other piezoelectric elements.

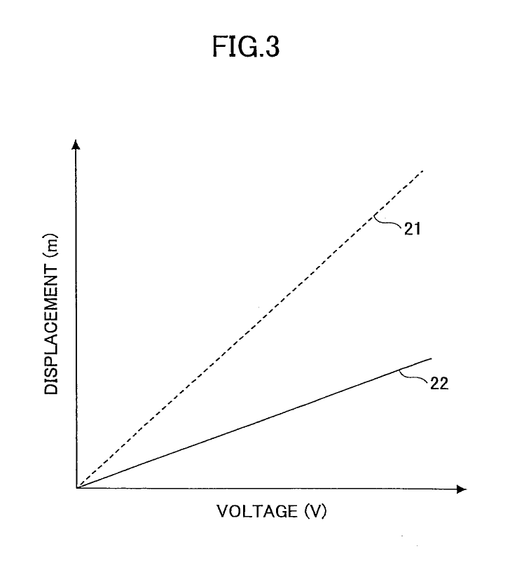

FIG. 3 is a graph indicating the piezoelectric characteristics of conventional piezoelectric elements. Numeral 21 designates the piezoelectric characteristics of a piezoelectric element as an actuator. Numeral 22 designates the piezoelectric characteristics of a piezoelectric element as a sensor. For example, when the first piezoelectric element 7a functions mainly as a sensor and the second piezoelectric element 7b is driven mainly as an actuator, the piezoelectric characteristics of the sensor should be such that a large output voltage can be obtained with a small amount of displacement, whereas the piezoelectric characteristics of the actuator should be such that a large amount of displacement can be obtained in response to a small amount of input voltage. Thus, by selecting the piezoelectric characteristics of the piezoelectric element depending on whether the piezoelectric element is mainly used as a sensor or an actuator, the function of each piezoelectric element can be optimized.

Preferably, in the fluid discharge head (inkjet head 100a) of the present embodiment, the shape of at least one piezoelectric element may be different from the shape of another piezoelectric element.

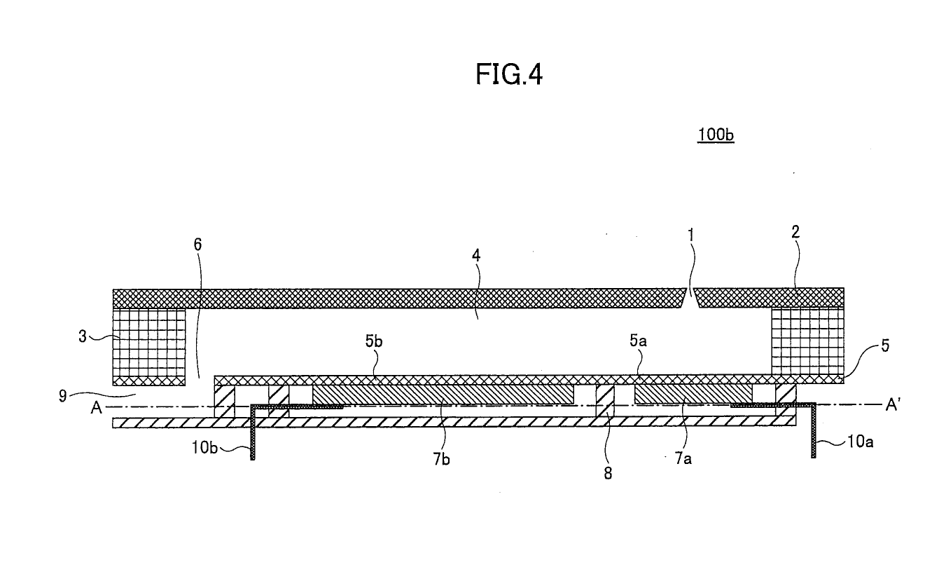

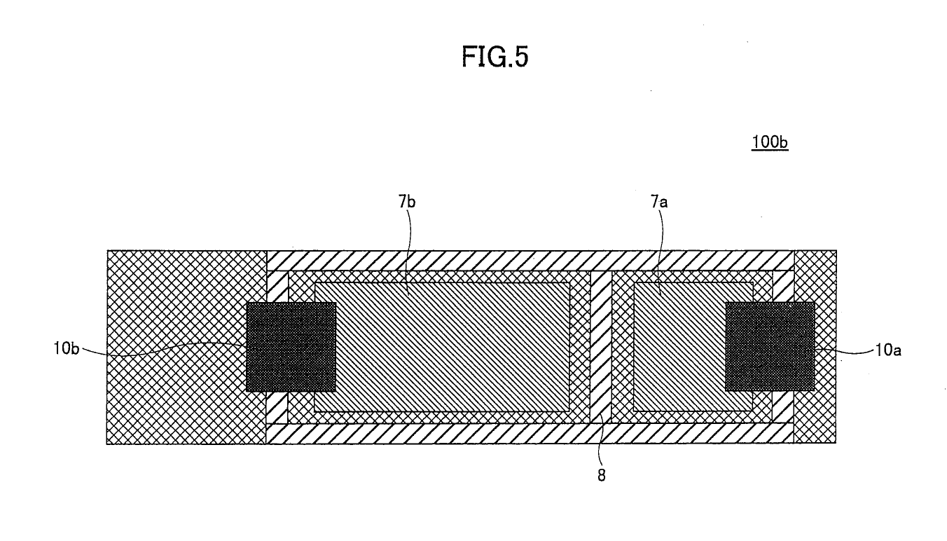

FIG. 4 is a cross section of an inkjet head 100b (fluid discharge head) according to another embodiment of the present invention. The inkjet head 100b includes a vibrating portion 5a for a first piezoelectric element 7a as a sensor and a vibrating portion 5b for a second piezoelectric element 7b as an actuator. Parts or elements of the inkjet head of the present invention similar to those of the foregoing embodiment are designated with similar numerals and their description is omitted. FIG. 5 is a bottom view of a cross section taken along the broken line A-A′ of FIG. 4.

When the first piezoelectric element 7a is operated mainly as a sensor and the second piezoelectric element 7b is driven to operate mainly as an actuator, it is necessary to cause the vibrating portion 5b to vibrate greatly because the actuator should provide as much kinetic energy to the ink as possible. On the other hand, the amount of displacement of the vibrating portion 5a for the sensor to detect a pressure may be relatively small.

Thus, as illustrated in FIGS. 4 and 5, the area of the first piezoelectric element 7a for the sensor is reduced compared to the area of the second piezoelectric element 7b for the actuator, thus optimizing the functions of the first and the second piezoelectric elements 7a and 7b.

Instead of, or in addition to, varying the areas of the piezoelectric elements 7a and 7b on the vibrating plate 5, the thickness of the piezoelectric elements 7a and 7b may be varied. For example, the thickness of the first piezoelectric element 7a for the sensor may be smaller than the thickness of the second piezoelectric element 7b for the actuator. Thus, the shape of the piezoelectric elements 7a and 7b may be optimized depending on their respective functions.

Preferably, in the inkjet head 100b according to the present embodiment, the material of at least one piezoelectric element may be different from the material of another piezoelectric element. For example, the first piezoelectric element 7a as the actuator may comprise a ceramics-based material capable of producing a large amount of displacement, such as Pb (Zr, Ti) O₃ (PZT). The second piezoelectric element 7b as the sensor may comprise a polymer material having a high sensitivity, such as polyvinylidene fluoride (PVDF).

Preferably, in the fluid discharge head according to the present embodiment, the rigidity of the vibrating portion for at least one piezoelectric element may be different from the rigidity of the vibrating portion for another piezoelectric element. In the embodiment illustrated in FIG. 1, when the first piezoelectric element 7a operates mainly as the sensor and the second piezoelectric element 7b is driven mainly as the actuator, the rigidity of the vibrating plate 5 should be such that the vibrating portion 5 can be greatly displaced with a small force.

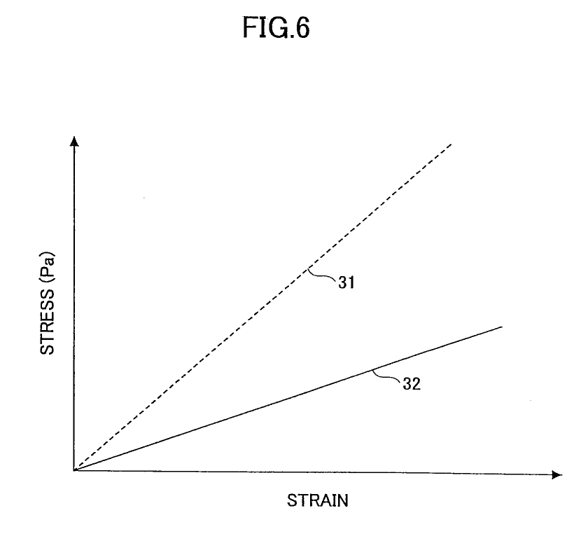

However, because the actuator should provide as much kinetic energy to the ink as possible, the amount of displacement (or strain) of the vibrating portion 5b for the actuator is increased compared to the amount of displacement (strain) of the vibrating portion 5a for the sensor. FIG. 6 is a graph illustrating stress-strain curves of conventional vibrating plate materials. Numeral 31 designates a stress-strain curve for a vibrating plate for an actuator while numeral 32 designates a stress-strain curve for a vibrating plate for a sensor. Thus, the function of each piezoelectric element can be optimized by adjusting the rigidity of the corresponding vibrating portion depending on the function of the piezoelectric element so that the maximum amount of displacement (strain) of each vibrating portion stays within an elastic deformation range.

Preferably, in the fluid discharge head according to the present embodiment, the thickness of the vibrating portion for at least one piezoelectric element may be different from the thickness of the vibrating portion for another piezoelectric element.

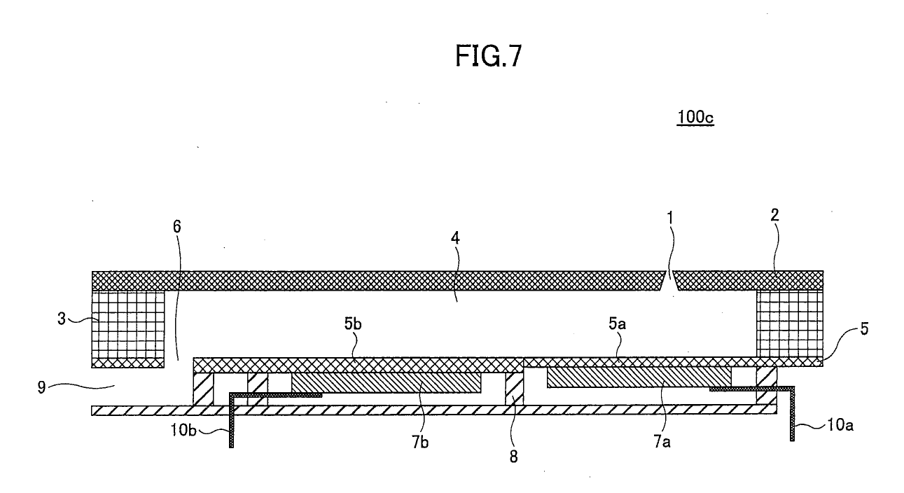

FIG. 7 is a cross section of an inkjet head 100c (fluid discharge head) according to another embodiment of the present invention. Because the actuator should provide as much kinetic energy as possible to the ink, the amount of displacement (strain) of the vibrating portion 5b for the actuator is greater than the amount of displacement (strain) of the vibrating portion 5a for the sensor. Thus, by making the vibrating portion 5b for the actuator thicker than the vibrating portion 5a for the sensor, the rigidity of the vibrating portion for each piezoelectric element can be optimized.

Preferably, in the fluid discharge head of the present embodiment, the vibrating portion for at least one piezoelectric element may have a layer structure different from the layer structure of the vibrating portion for another piezoelectric element.

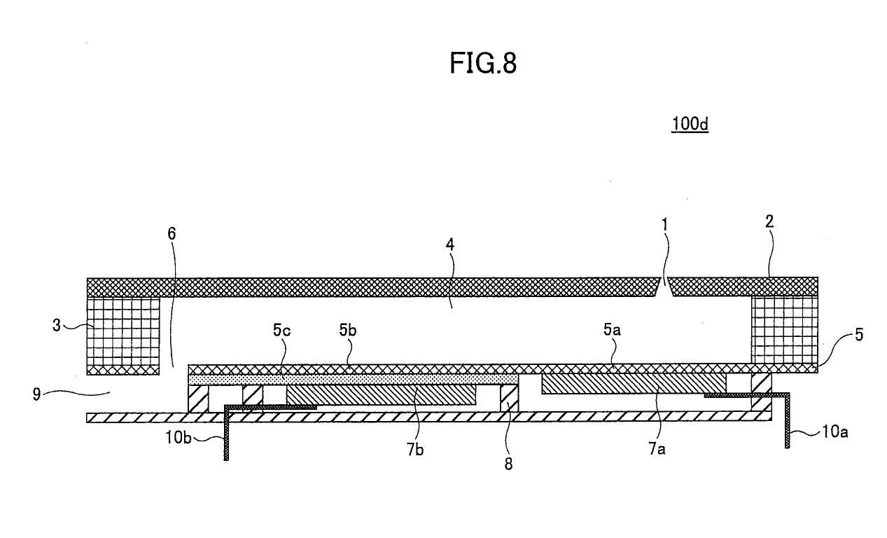

FIG. 8 is a cross section of an inkjet head 100d (fluid discharge head) according to another embodiment of the present invention. Because the actuator should provide as much kinetic energy to the ink as possible, the amount of displacement (strain) of the vibrating portion 5b for the actuator is increased compared to the amount of displacement (strain) of the vibrating portion 5a for the sensor. Thus, in accordance with the present embodiment, a layer 5c is provided under the vibrating portion 5b for the actuator. By thus increasing the number of layers in the layer structure of the vibrating portion 5b for the actuator relative to the vibrating portion 5a for the sensor, the rigidity of the vibrating portion for each piezoelectric element can be optimized.

Preferably, in the fluid discharge head according to the present embodiment, the material of the vibrating portion for at least one piezoelectric element may be reformed and thereby made different from the material of the vibrating portion for another piezoelectric element.

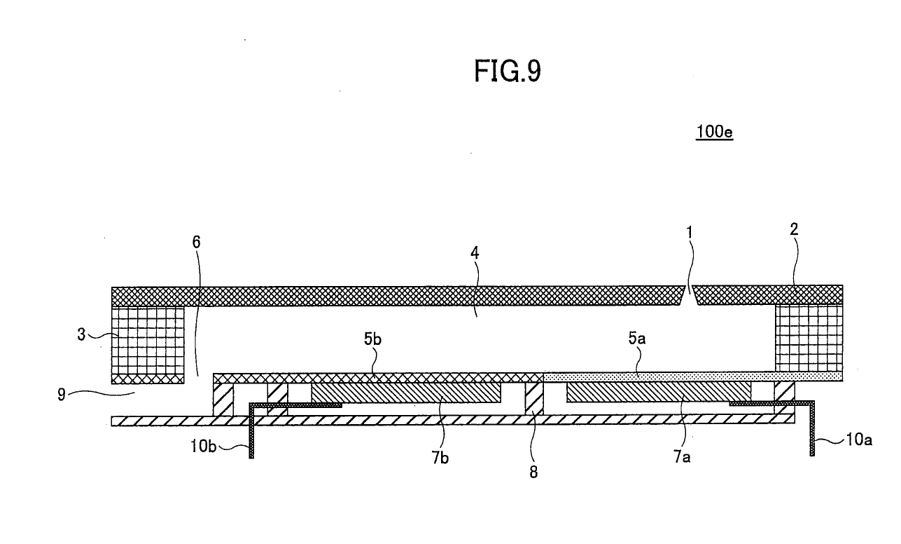

FIG. 9 is a cross section of an inkjet head 100e (fluid discharge head) according to another embodiment of the present invention. Because the actuator should provide as much kinetic energy to the ink as possible, the amount of displacement (strain) of the vibrating portion 5b for the actuator is increased compared to the amount of displacement (strain) of the vibrating portion 5a for the sensor. Thus, in accordance with the present embodiment, the material of vibrating portion 5b for the actuator is reformed so that the vibrating portion 5b for the actuator is more rigid than the vibrating portion 5a for the sensor. Thus, the rigidity of the vibrating portion for each piezoelectric element can be optimized. The material of the vibrating portion 5b for the actuator may be reformed by ion plating, thermal spraying, or by forming a molecular-bond film using a surface reforming/reinforcing agent. Because it is difficult and costly to attach vibrating plates of different materials to one another in the same layer, the partial reforming process according to the present embodiment may be more preferable. In this way, the fluid discharge head 100d can be manufactured easily and at less cost.

Preferably, the first and the second piezoelectric elements 7a and 7b of the fluid discharge head according to the various embodiments of the present invention may be fabricated by a solution (sol-gel) process, an inkjet patterning process, and/or a process involving optical energy.

Generally, ceramics products or components are manufactured by a melting process. However, a melting process typically requires melting raw ceramics material at a high temperature of 1000° C. or above. On the other hand, a solution (sol-gel) process involves chemical reactions such as hydrolysis and condensation polymerization in preparing a ceramics material gel. The gel is then subjected to a relatively low-temperature thermal treatment in order to evaporate the internally remaining solvent, thereby crystallizing the ceramics material and obtaining a desired ceramics component. Because the solution (sol-gel) process does not require the burning of raw material at a high temperature of 1000° C. or above as required by the melting process, the solution process may be more advantageous in that it is less likely to damage the vibrating plate on which a piezoelectric element is formed, or an electrode layer.

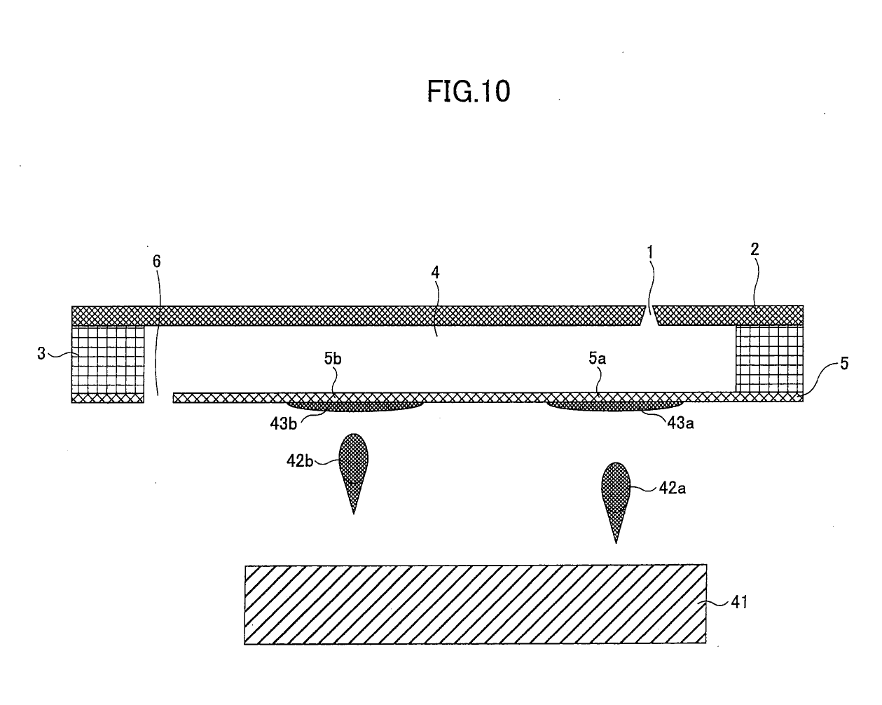

FIG. 10 illustrates an inkjet patterning process involving an inkjet patterning apparatus 41. The inkjet patterning apparatus 41 is configured to discharge droplets 42a and 42b of a ceramics solution (sol-gel solution). The droplets 42a and 42b of ceramics solution land on the vibrating plate 5, forming areas 43a and 43b of the ceramics material where piezoelectric elements are to be formed. The ceramics solution landed in the areas 43a and 43b of the vibrating plate 5 is heated at several hundred ° C. in order to evaporate the solvent. The dried ceramics material is further heated at a temperature of 500° C. or above in order to crystallize the ceramics and form the piezoelectric elements as required.

Such an inkjet patterning process is advantageous in that it allows for more efficient utilization of the material solution than other patterning techniques, such as etching. In the case of etching, the material in areas other than those areas that should be left as a pattern is eventually discarded. On the other hand, the inkjet patterning process does not involve such discarding, so that the cost of the final product can be reduced and environmental burden due to such discarding of material can be reduced. Furthermore, the inkjet patterning process enables the material and/or thickness, for example, of the piezoelectric elements for actuator and sensor to be easily varied. Thus, in the case of inkjet patterning process, the number of required processing steps can be reduced and a further cost reduction can be achieved.

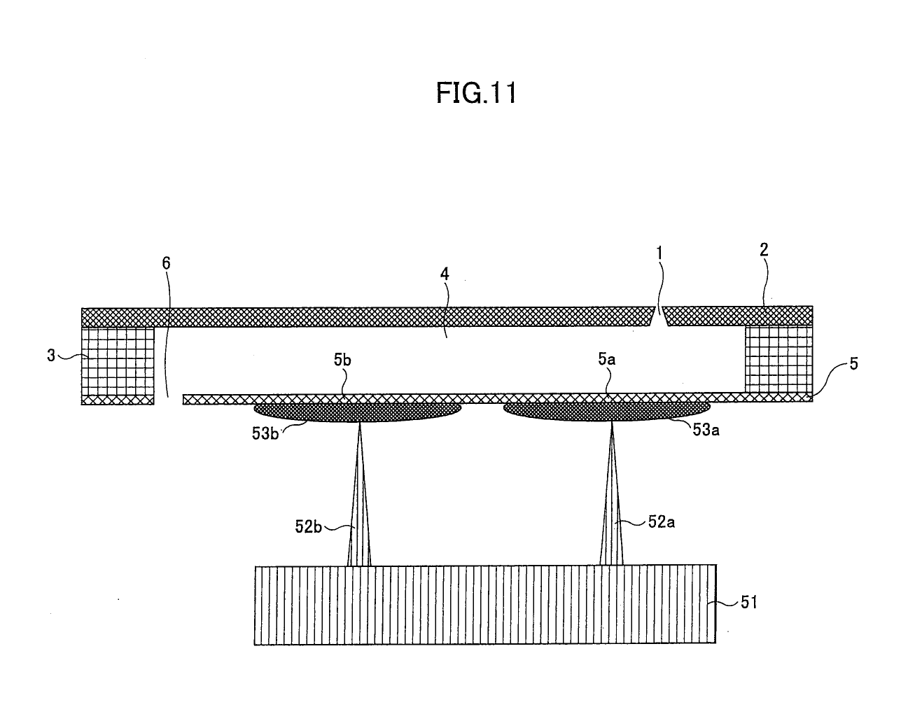

FIG. 11 illustrates a process of forming a piezoelectric element by evaporation of the solvent in a sol-gel solution and subsequent crystallization of the ceramics material, using optical energy. A similar process may also be used for reforming the material of the vibrating plate, as mentioned above. A light source 51 is configured to emit beams 52a and 52b of optical energy with which a ceramics solution that has landed in areas 53a and 53b on the vibrating plate 5 is irradiated. The ceramics solution in the areas 53a and 53b on the vibrating plate 5 is heated by the optical energy to a temperature on the order of several hundred degrees Celsius, whereby the solvent is evaporated. The dried ceramics is further heated by the optical energy to a temperature of 500° C. or above, whereby the ceramics is crystallized and a piezoelectric element is formed.

In this way, a piezoelectric element can be efficiently manufactured because the process involves focusing optical energy so that only the required pattern of the ceramics solution is heated. Further, the above described process does not heat portions other than where the ceramics solution is present, so that no thermal burden is placed on the unwanted portions. As a result, reliability of the final product can be improved. The process involving optical energy is also advantageous in that it can provide optical energy to the solution in flight (i.e., before it lands on the vibrating plate 5) so that the physical property of the solution can be controlled during its flight. Furthermore, by heating a landing area with optical energy before the solution lands in it, the rate of drying of the solvent and crystallization of the ceramics material can be increased. The optical energy process may also enable the surface state of the landing area to be controlled. When the material, thickness, and the like of one piezoelectric element differs from those of another piezoelectric element depending on whether the piezoelectric element is used as a sensor or an actuator, the optical energy may be optimized for each piezoelectric element.

### Image Forming Apparatus

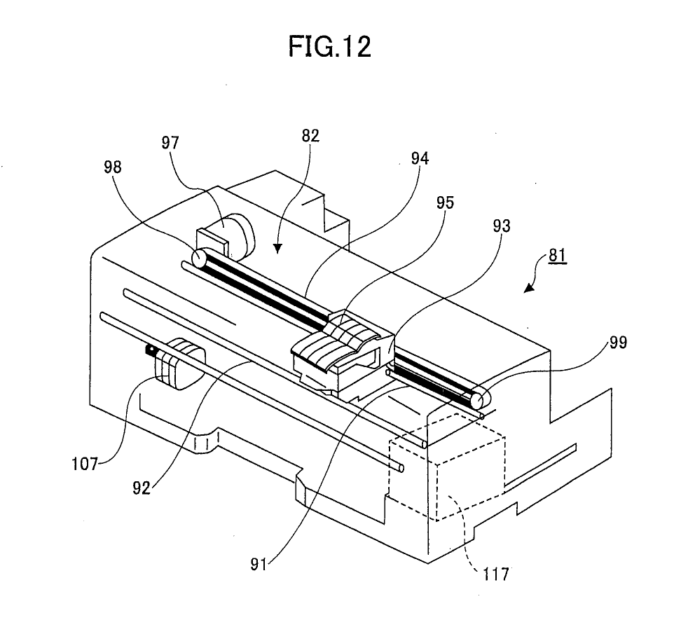

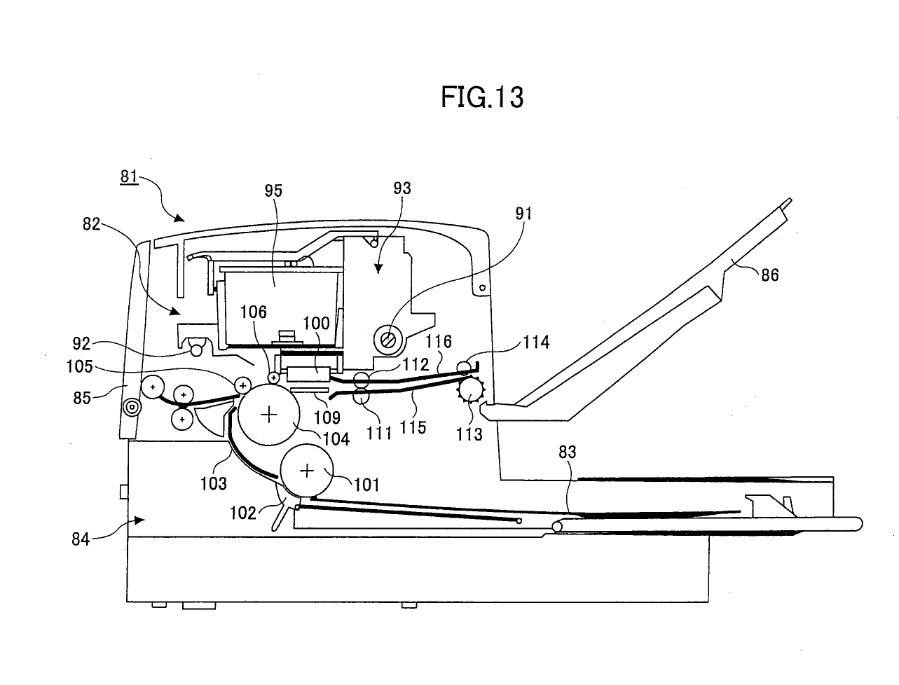

Next, an inkjet recording apparatus 81 according to an embodiment of the present invention is described with reference to FIGS. 12 and 13. FIG. 12 is a perspective view of the inkjet recording apparatus 81. FIG. 13 is a side view of the inkjet recording apparatus 81.

The inkjet recording apparatus 81 includes a printing mechanism portion 82. The printing mechanism portion 82 includes a carriage 93 configured to be moved in a main scan direction. The carriage 93 supports an inkjet head (recording head) 100 according to an embodiment of the present invention. The printing mechanism portion 82 also includes an ink cartridge 95 configured to supply various colors of ink to the inkjet head 100. Under the printing mechanism portion 82, a detachable sheet-feeding cassette (or tray) 84 may be installed. A sheet 83 may be manually fed by opening a manual-feed tray 85. The sheet 83 which may be fed either via the sheet-feeding cassette 84 or the manual-feed tray 85 is fed to the printing mechanism portion 82, where a required image is recorded on the sheet 83. Subsequently, the sheet 83 is ejected into an ejected sheet tray 86.

The printing mechanism portion 82 further includes a main guide rod 91 (guide member) and a sub-guide rod 92 which are laterally disposed between side plates (not shown). The main guide rod 91 and the sub-guide rod 92 are configured to support the carriage 93 slidably along the main scan direction. The inkjet head 100 mounted on the carriage 93 may include a plurality of heads configured to discharge ink droplets of the colors yellow (Y), cyan (C), magenta (M), and black (Bk). The inkjet head 100 may have plural ink discharge openings (nozzles) arranged along a direction perpendicular to the main scan direction. The nozzles of the ink head 94 may be directed downward so that the ink droplets can be discharged downward. The carriage 93 may also support a plurality of replaceable ink cartridges 95 for supplying the various colors of ink to the head 94.

Each of the ink cartridges 95 may have an opening in their upper portions for communication with the atmosphere, and a supply opening in their lower portions for the supply of ink to the inkjet head 94. The ink cartridges 95 may contain a porous body filled with ink. The ink in the ink cartridges 95 may be slightly negatively pressured by the capillary force of the porous body. Preferably, the inkjet head 100 may comprise a single head having nozzles configured to discharge the various colors of ink droplets.

A back side (i.e., downstream side along a sheet transport direction) of the carriage 93 may be slidably supported by the main guide rod 91, while a front side (i.e., upstream side in the sheet transport direction) of the carriage 93 may be slidably supported by the sub-guide rod 92. A timing belt 94 is extended between a drive pulley 98, which is rotated by a main scan motor 97, and a driven pulley 99. The timing belt 94 is connected to the carriage 93 so that the carriage 93 can be moved back and forth along the main scan direction by forward and backward rotation of the main scan motor 97.

The sheet 83 set in the sheet-feeding cassette 84 is transported to a recording area under the head 94 by a sheet transport mechanism. The sheet transport mechanism may include a sheet-feed roller 101 and a friction pad 102 for separating and feeding the sheet 83 from the sheet-feeding cassette 84; a guide member 103 for guiding the sheet 83; a transport roller 104 for turning the sheet 83 upside down; a transport roller 105 pressed against the peripheral surface of the transport roller 104; and an edge roller 106 configured to define the angle at which the sheet 83 is sent out of the transport roller 104. The transport roller 104 may be configured to be rotated by a sub-scan motor 107 via a series of gears.

The sheet 83 fed out of the transport roller 104 is guided by a sheet guide member 109 configured to guide the sheet 83 under the recording head 94. The sheet guide member 109 may extend as wide as the range of movement of the carriage 93 in the main scan direction. Downstream of the sheet guide member 109 in the sheet transport direction, there are disposed a transport roller 111 and a spur 112 for sending the sheet 83 in the direction of the ejection sheet tray 86. Further downstream along the sheet transport direction, an ejection roller 113 and a spur 114 are disposed for sending the sheet 83 out onto the ejected sheet tray 86. A sheet ejection path is formed by guide members 115 and 116.

During a recording operation, the recording head 94 is driven to discharge droplets of ink onto the sheet 83 in accordance with an image signal while the carriage 93 is moved. After a line of image is recorded on the sheet 83 when it is stationary, the sheet 83 may be moved by a predetermined amount so that the next line can be recorded. The recording operation ends in response to a record end signal or a signal indicating that the rear edge of the sheet 83 has reached the recording area, followed by the ejection of the sheet 83.

A restoring unit 117 may be disposed outside the recording area, such as on one side of the carriage 93 along the direction of its movement. The restoring unit 117 is configured to restore a required level of performance of the inkjet head 100 by eliminating one or more causes of discharge defect from the head 94. Specifically, the restoring unit 117 may include a cap unit, a suction unit, and a cleaning unit, which are not illustrated. During a standby period, the carriage 93 may be moved to the restoring unit 117, where the head 100 may be capped with the cap unit in order to maintain the discharge openings of the inkjet head in a wet condition, thus preventing discharge defect due to the drying of ink. Further, the head 94 may be caused to discharge ink that does not contribute to recording during a recording operation by the suction unit of the restoring unit 117. In this way, the viscosity of the ink in all of the discharge openings may be made constant, so that a stable discharge performance of the head 100 can be maintained.

In the event of a defective discharge, the discharge openings (nozzles) of the head 100 may be sealed with the cap unit, and then bubbles and the like may be sucked out of the discharge openings, together with ink, via tubing and using the suction unit. Any ink or dust that may have attached to the discharge opening surfaces are removed by the cleaning unit, thereby restoring a required level of head performance. The ink that has been sucked out of the nozzles may be ejected into a waste ink pan (not shown) which may be installed under the printing mechanism portion 82, where the waste ink may be absorbed and retained in an ink absorbing material.

In an embodiment of the present invention, the inkjet head 100 may include three or more piezoelectric elements instead of two as in the foregoing embodiments. In such an embodiment, too, the vibrating plate 5 may be delineated into vibrating portions so that the individual piezoelectric elements attached to the vibrating plate 5 can be independently displaced, wherein at least one of the piezoelectric elements may be used as a pressure detecting unit.

The fluid discharge head according to an embodiment of the present invention may be applied for various technologies other than printing technology. Examples include technologies for producing various industrial products using an inkjet process, such as electronic wiring, insulating film coating, and color filters for thin display units.

Thus, in accordance with the various embodiments of the present invention, at least one of the piezoelectric elements is used as a pressure detecting unit configured to detect an ink pressure in a fluid chamber. When it is not necessary to detect the pressure in the pressure chamber, the at least one piezoelectric element may be used as an actuator configured to provide kinetic energy to the ink in the fluid chamber. Thus, the range of control of the amount of discharged ink can be increased. For example, when a small droplet needs to be discharged, only one of the piezoelectric elements may be driven; when a large droplet needs to be discharged, two or more of the piezoelectric elements may be driven.

Thus, in accordance with the various embodiments of the present invention, improved dot gradation can be obtained and a high-quality image can be printed. Further, abnormality in the fluid chamber can be detected, the structure of the fluid discharge head can be simplified, and the number of manufacturing steps and manufacturing cost can be reduced.

Although this invention has been described in detail with reference to certain embodiments, variations and modifications exist within the scope and spirit of the invention as described and defined in the following claims.

The present application is based on the Japanese Priority Application No. 2009-131927 filed Jun. 1, 2009, the entire contents of which are hereby incorporated by reference.

What is claimed is:

1. A fluid discharge head comprising:
a fluid chamber configured to be filled with ink;
a discharge opening configured to discharge a droplet of ink from the fluid chamber;
a plurality of piezoelectric elements configured as displacement generating units to provide kinetic energy to the ink for the discharge of the ink droplet; and
a vibrating plate forming a part of the fluid chamber and connected to the piezoelectric elements, the vibrating plate being configured to transmit a displacement generated by the piezoelectric elements to the ink in the fluid chamber,
wherein the vibrating plate includes vibrating portions for the respective piezoelectric elements,
wherein the vibrating portions are configured to be independently displaced for the corresponding piezoelectric elements, and
wherein at least one of the piezoelectric elements is configured as a pressure detecting unit to detect an ink pressure in the fluid chamber.

2. The fluid discharge head according to claim 1, wherein the piezoelectric characteristics of at least one of the piezoelectric elements are different from the piezoelectric characteristics of another one of the piezoelectric elements.

3. The fluid discharge head according to claim 1, wherein the shape of at least one of the piezoelectric elements is different from the shape of another one of the piezoelectric elements.

4. The fluid discharge head according to claim 1, wherein the material of at least one of the piezoelectric elements is different from the material of another one of the piezoelectric elements.

5. The fluid discharge head according to claim 1, wherein the rigidity of at least one of the vibrating portions is different from the rigidity of another one of the vibrating portions.

6. The fluid discharge head according to claim 1, wherein the thickness of at least one of the vibrating portions is different from the thickness of another one of the vibrating portions.

7. The fluid discharge head according to claim 1, wherein at least one of the vibrating portions has a different number of layers from a number of layers of another one of the vibrating portions.

8. The fluid discharge head according to claim 1, wherein the material of at least one of the vibrating portions is different from the material of another one of the vibrating portions due to a reforming process.

9. The fluid discharge head according to claim 1, wherein the piezoelectric elements are formed by a sol-gel process, an inkjet patterning process, and/or a process involving optical energy.

10. An image forming apparatus comprising the fluid discharge head according to claim 1.
